(19) United States
(12) Patent Application Publication
(10) Pub. No.: US 2025/0382038 A1
(43) Pub. Date: Dec. 18, 2025

(54) SYSTEMS AND METHODS OF REMOTELY CONTROLLING COMMUNICATION DEVICES

(71) Applicant: NAVICO GROUP AMERICAS, LLC, Menomonee Falls, WI (US)

(72) Inventors: Leigh Armstrong, Auckland (NZ); Adam M. King, Auckland (NZ); Greig Keesing, Auckland (NZ)

(21) Appl. No.: 18/743,378

(22) Filed: Jun. 14, 2024

(51) Int. Cl. B63B 49/00; B63B 45/08; G01S 13/937

(52) U.S. Cl. CPC B63B 49/00; B63B 45/08; G01S 13/937

(57) ABSTRACT

Systems and methods for controlling a remotely located very high frequency (VHF) radio are provided herein. A system includes a VHF radio comprising a communication interface, a processor, and a memory including computer program code (CPC). The CPC is configured to, when executed, cause the processor to receive and transmit data. The system further comprises a marine electronics device (MED) remotely located from and in data communication with the VHF radio. The MED comprises a display, a processor, and a memory comprising CPC. The CPC is configured to receive at least one operational setting of the VHF radio, and cause on the display presentation of the operational setting. The CPC is further configured to receive an input at the display to change the at least one operational setting and send a signal to the VHF radio to execute the change in the at least one operational setting.

### FIELD

Embodiments of the present invention relate generally to controlling remote devices, and, more particularly to, providing users the ability to interface and control a remotely located communication device, for example a very high frequency (VHF) radio, from a marine electronics device.

### BACKGROUND

Communication devices including for example, very high frequency (VHF) radios, automatic identification systems (AIS), and VHF data exchange systems (VDES) are safety features on many watercrafts, including recreational watercrafts, and may be required on watercrafts. The communication devices, including VHF radios, have historically been positioned near the helm of a watercraft, or in a position easily reachable from the helm of the watercraft. VHF radios allow the operator or other users of the watercraft to communicate with nearby watercrafts and/or the coast guard, such as by receiving messages, alerts, or similar. Similarly, AIS and VDES operate on VHF frequencies and may be used for higher data throughput, and collision avoidance, and navigation safety.

The central location of the communication devices, for example, at the helm or steering center of the watercraft, provides an ease of access to hear incoming messages, send out going messages, and utilize the functionality of the device (e.g., send message, change channel, adjust volume, scan across multiple channels).

Advancements in marine technology including in sonar, radar, and other visual aids are driving preference for display of such imagery in prominent positions relative to the helm. Further, watercraft operators are desiring larger and/or more displays in the form of marine electronics devices. Accordingly, other communication devices, including VHF radios, are often relocated to positions away from the helm and/or less prominent positions. Additionally, there are some communication devices which may require large antennas or may be too large to fit at the helm, and thus, such communication devices are often remotely located from the helm. Accordingly, it is often the case that the communication device is not within a direct line of sight and/or is not easily accessible by the watercraft operator.

### BRIEF SUMMARY OF THE INVENTION

Given the foregoing, there exists a need to provide access and use of the communication devices, including VHF radio, AIS, and VDES at the helm, even when the communication device is remotely located or less prominently positioned. Further, with increased communication, the user should be able to transmit and receive messages, and adjust the operational settings of the communication device, while being remote therefrom.

The present invention includes a system for use on a watercraft which enables communication between a marine electronics device and a communication device. The VHF radio includes an antenna, a communications interface, a processor. The communication device can receive and transmit message data. The marine electronics device may be in data communication with the communication device such that data including operational settings, message data and other types of data may be communicated between the two devices. Further, the data communication between the communication device and the marine electronics devices may allow an action taken at the communication device to be reflected on the marine electronics device, and similarly allow an action taken at the marine electronics device to cause a corresponding change to be made at the communication device.

Further, in some embodiments, ability to control and/or utilize data, messages, etc. from the communication device through the marine electronics device provides increased functionality that can be offered to the watercraft operator. Some such example functionality includes, for example, providing automated safety protocols, providing communication options with other vessels, among other things.

In an example embodiment, a system for use on a watercraft is provided herein. The system comprises a VHF radio and a marine electronics device, the VHF radio comprises an antenna, a communication interface, a processor and a memory comprising a computer program code. The computer program code is configured to, when executed, cause the processor to receive, via the communication interface, message data, and transmit the communication interface, message data. The marine electronics device is remotely located from the VHF radio, and the marine electronics device is in data communication with the VHF radio. The marine electronics device comprises a display, a processor and a memory including computer program code. The computer program code is configured to, when executed, cause the processor to receive through data communication with the VHF radio, at least one operational setting of the VHF radio. The computer program code is further configured to cause, on the display, presentation of the at least one operational setting. The computer program code is further configured to receive at an input, at the display, to change the at least one operational setting of the VHF radio, and send a signal to the VHF radio to execute the change to the at least one operational setting of the VHF radio.

In some embodiments, the at least one operational setting may be one of an operating channel, a volume, a power setting, an identifier of the VHF radio, a location of the VHF radio, an operation frequency or a squelch. In some embodiments, the at least one operational setting may be an operating channel. The computer program code of the marine electronics device may be further configured to, when executed, cause the processor to receive through data communication with the VHF radio, a status indication of the operating channel, and cause, on the display, presentation of the status indication of the operating channel.

In some embodiments, the computer program code of the VHF radio, may be further configured to when executed, cause the processor to receive at the communication interface of the VHF radio an indication of an incoming message. The computer program code may be further configured to transmit, via the communication interface, the incoming message to the marine electronics device, and cause, on the display, presentation of the incoming message. In some embodiments, the computer program code of the VHF radio may be further configured to, when executed, cause the processor to receive at the communication interface of the VHF radio an indication of a vessel corresponding to the incoming message and corresponding contact information, and save, in the memory of the VHF radio, the contact information.

In some embodiments, the computer program code of the marine electronics device may be further configured to, when executed, cause the processor to receive through user input an indication of engagement in digital selective calling (DSC) and cause of the display, presentation of a list of contacts. The computer program code may be further configured to receive at the display, an indication of a selected contact and send a signal to the VHF radio to engage in DSC calling with the selected contact.

In some embodiments, the system may further comprise at least one radar associated with the watercraft. The at least one radar may be configured to emit one or more electromagnetic waves in a direction relative to the watercraft. The computer program code of the marine electronics device may be configured to, when executed, cause the processor to cause the at least one radar to emit one or more electromagnetic waves, and receive radar return data corresponding to radar returns received by the at least one radar. The computer program code may be further configured to generate a radar image corresponding to the radar return data, and detect one or more objects in the radar return data. The computer program code may be further configured to cause, on the display, presentation of the one or more detected objects within the radar image, and to cause, automatically in response to determining that a detected object from among the one or more detected objects is within a predetermined distance of the watercraft, the VHF radio to transmit a message to the detected object. In some embodiments, the message may be stored within the memory of the marine electronics device. In some embodiments, the message may be stored within the memory of the VHF radio.

In some embodiments, the computer program code of the marine electronics device may be further configured to, when executed by the processor to receive, at the display of the marine electronics device, an indication of the engagement of a foghorn, and transmit, via the communication interface, a signal to the VHF radio to engage the foghorn, and cause the VHF radio to engage the foghorn.

In some embodiments, the computer program code of the marine electronics device may be further configured to, when executed, cause the processor to receive an indication of a location of the VHF radio and cause, on the display of the marine electronics device, presentation of the indication of the location of the VHF radio.

In some embodiments, the computer program code of the marine electronics device may be further configured to, when executed, cause the processor to receive at the display of the marine electronics device, an indication of an input, wherein the input is a VHF radio mode. The computer program code may be further configured to transmit, via the communication interface, a signal to the VHF radio to engage in the VHF radio mode, and cause the VHF radio to change the VHF radio mode. In some embodiments, the VHF radio mode may be one of a single channel, scanning, squelch, silence, weather, man overboard, and distress.

In some embodiments, the computer program code of the VHF radio may be further configured to, when executed, cause the processor to receive at the VHF radio an indication of a change in at least one operational setting, and send, via the processor, instructions to the marine electronics device to cause a change in the operational setting. The computer program code of the marine electronics device may be further configured to cause, on the display of the marine electronics device, presentation of the changed operational setting.

In another example embodiment a marine electronics device is provided. The marine electronics device comprises a display, a processor and a memory, including computer program code configured to, when executed, cause the processor to receive through data communication, at least one operational setting from a VHF radio, wherein the VHF radio is remote from the marine electronics device. The computer program code is further configured to cause, on the display, presentation of the at least one operational setting, and receive an indication for the VHF radio to execute one or more actions corresponding to the operational setting. The computer program code, is further configured to transmit instructions to the VHF radio to cause execution of the oner or more actions by the VHF radio, wherein the one or more actions at least change the operational setting of the VHF radio.

In some embodiments, the at least one operational setting may be one of an operating channel, a volume, a power setting, an identifier of the VHF radio, a location of the VHF radio, an operation frequency or a squelch.

In some embodiments, the computer program code may be further configured to, when executed, cause the processor to receive, at the display of the marine electronics device, an indication of an input, wherein the input is a VHF radio mode, and transmit a signal to the VHF radio to engage in the VHF radio mode so as to cause the VHF radio to change the VHF radio mode. In some embodiments, the VHF radio mode is one of single channel, scanning, squelch, weather, man overboard, and distress.

In another embodiment, a method of using a VHF radio is provided. The method comprises causing, on a display of a marine electronics device, presentation of at least one operational setting of the VHF radio, wherein the marine electronics device is connected with the VHF radio so as to provide data communication between the marine electronics device and the VHF radio. The method further comprises receiving at the display of the marine electronics device, an indication of a change in the at least one operational setting. The method further comprises sending a signal to the VHF radio to execute the change to the at least one operational setting.

In some embodiments, the at least one operational setting may be one of an operating channel, a volume, a power setting, an identifier of the VHF radio, a location of the VHF radio, an operation frequency or a squelch.

In yet another example embodiment, a system for use on a watercraft is provided. The system comprises a communication device and a marine electronics device, the communication device comprises an antenna, a communication interface, a processor and a memory comprising a computer program code. The computer program code is configured to, when executed, cause the processor to receive, via the communication interface, message data, and transmit the communication interface, message data. The marine electronics device is remotely located from the communication device, and the marine electronics device is in data communication with the communication device. The marine electronics device comprises a display, a processor and a memory including computer program code. The computer program code is configured to, when executed, cause the processor to receive through data communication with the communication device, at least one operational setting of the communication device. The computer program code is further configured to cause, on the display, presentation of the at least one operational setting. The computer program code is further configured to receive at an input, at the display, to change the at least one operational setting of the communication device, and send a signal to the communication device to execute the change to the at least one operational setting of the communication device.

### BRIEF DESCRIPTION OF THE DRAWINGS

Reference will now be made to the accompanying drawings, which are not necessarily drawn to scale, and wherein:

FIG. 1 illustrates an example watercraft including various marine devices, in accordance with some embodiments discussed herein;

FIG. 2 illustrates a helm of a watercraft, including multiple example marine electronics devices and a very high frequency (VHF) radio, in accordance with some embodiments discussed herein;

FIG. 3A illustrates an example marine electronics device presenting a navigational chart and example interactive menus, in accordance with some embodiments discussed herein;

FIG. 3B illustrates the example marine electronics device presenting the navigational chart and interactive menus, in accordance with some embodiments discussed herein;

FIG. 4 illustrates an example marine electronics device presenting a navigational chart and interactive menus, in accordance with some embodiments discussed herein;

FIGS. 5A-D illustrate utilizing the example marine electronics device to change an operational setting of an example VHF radio, in accordance with some embodiments discussed herein;

FIGS. 6A-C illustrates an example marine electronics device interfacing with the example VHF radio to engage in digital select calling, in accordance with some embodiments discussed herein;

FIGS. 7A-B illustrate an example marine electronics device detecting a watercraft and sending a message via the example VHF radio, in accordance with some embodiments discussed herein;

FIG. 8 illustrates the example marine electronics device interfacing with the example VHF radio to engage a horn signal, in accordance with some embodiments discussed herein;

FIG. 9 illustrates a block diagram of an example system with various electronic devices, marine devices, and secondary devices shown, in accordance with some embodiments discussed herein; and

FIG. 10 illustrates a flowchart of an example method of interfacing with a VHF from a marine electronics device to cause a change in an operational setting at the VHF radio, in accordance with some embodiments discussed herein.

### DETAILED DESCRIPTION

Example embodiments of the present invention now will be described more fully hereinafter with reference to the accompanying drawings, in which some, but not all embodiments of the invention are shown. Indeed, the invention may be embodied in many different forms and should not be construed as limited to the example embodiments set forth herein; rather, these embodiments are provided so that this disclosure will satisfy applicable legal requirements. Like reference numerals refer to like elements throughout.

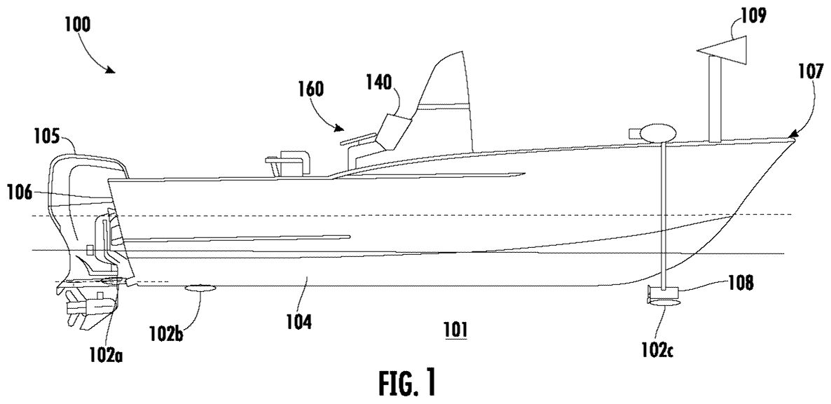

FIG. 1 illustrates an example watercraft 100 including various marine devices, in accordance with some embodiments discussed herein. As depicted in FIG. 1, the watercraft 100 (e.g., a vessel) is configured to traverse a marine environment, e.g., body of water 101, and may use one or more sonar transducer assemblies 102 disposed on and/or proximate to the watercraft. Notably, the example watercraft 100 contemplated herein may be a surface watercraft, a submersible watercraft, or any other implementation known to those skilled in the art. The transducer assemblies 102a, 102b, 102c may each include one or more transducer elements configured to transmit sound waves into a body of water, receive sonar returns from the body of water, and convert the sonar returns into sonar return data. Various types of sonar transducers may be provided—for example, a linear downscan sonar transducer, a conical downscan sonar transducer, a sonar transducer array, an assembly with multiple transducer arrays, or a sidescan sonar transducer may be used, among others. The transducer assemblies 102a-c may be mounted at various locations on the watercraft, such as being mounted to the hull (transducer assembly 102a), through the hull (transducer assembly 102b), or to a trolling motor 108 (transducer assembly 102c).

Depending on the configuration, the watercraft 100 may include a primary motor 105, which may be a main propulsion motor such as an outboard or inboard motor located at the stern 106 of the watercraft. Additionally, the watercraft 100 may include the trolling motor 108 configured to, for example, propel the watercraft 100 and/or maintain a position. In the illustrated embodiment, the trolling motor 108 is located at the fore 107 of the watercraft 100, but other positions are located.

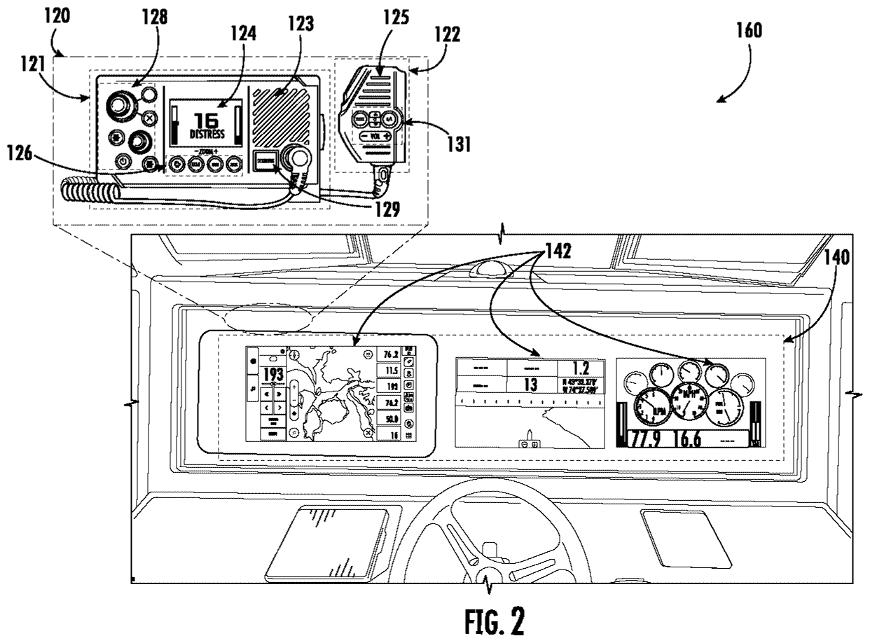

The watercraft 100 may also include one or more marine electronics devices 140, such as may be utilized by a user to interact with, view, or otherwise control various functionality regarding the watercraft, including, for example, nautical charts and various sonar systems. In the illustrated embodiment, the marine electronics device 140 may be positioned proximate the helm 160 (e.g., steering wheel) of the watercraft 100—although other places on the watercraft 100 are contemplated. Likewise, additionally or alternately a number of communication devices, for example, a very high frequency (VHF) radio 120 (See FIG. 2) may be positioned on the watercraft 100. In some embodiments, the VHF radio 120 may be positioned at the helm 160 of the watercraft 100, while in other embodiments, the VHF radio 120 may be positioned away from the helm 160, for example, at the stern, or below deck. Similarly, in some embodiments, other communication devices, for example, an AIS transceiver, and/or a VHF Data Exchange System (VDES) transceiver may be positioned at the helm 160, and in other embodiments may be positioned away from the helm in a similar location to the VHF radio 120. In this regard, the VHF radio 120, and other communication devices, may not be easily accessible from a user positioned at the helm 160, and in some embodiments, may not be visible to a user positioned at the helm 160. However, access to the communication devices to utilize the functionality may be imperative to safety while operating the watercraft 100, and thus, there exists a need to provide users control over the communication devices, even when the communication devices are remote from the users location.

The watercraft 100 may also comprise other components, such as within the one or more marine electronics devices 140 or at the helm 160. In some embodiments, the watercraft 100 may also comprise a direction sensor, and/or other sensors, and these components may be positioned at or near the helm (although other positions relative to the watercraft are also contemplated). In other embodiments, these components may be integrated into the one or more electronic devices 140 or other devices. Other example devices include a wind sensor, one or more speakers, and various vessel devices/features (e.g., doors, bilge pump, fuel tank, etc.), among other things. Additionally, one or more sensors may be associated with marine devices; for example, a position sensor may be provided to detect the position of various marine devices individually.

FIG. 2 illustrates an example helm 160 of the watercraft 100. In some embodiments, the helm 160 may include the marine electronics device 140 and a very high frequency (VHF) radio 120. In some embodiments, the marine electronics device 140 may comprise at least one screen (e.g., display) 142, which presents data to the user. In some embodiments, the at least one screen 142 may present a chart of the body of water being navigated by the watercraft, a chart of the current location and heading of the watercraft, one or more sonar images of the underwater environment, current statistics of the watercraft (e.g., speed, heading, fuel remaining, etc.), among other things.

In some embodiments, the very high frequency (VHF) radio 120 may be positioned near the helm 160, and, in some instances, may be built into the helm 160 of the watercraft. The VHF radio 120 may include a base 121, which is positioned near the helm 160, within the helm 160, or in another position on the watercraft 100. In some embodiments, the base 121 may comprise a speaker 123, a screen (e.g., display) 124, channel operations 126, one or more selections buttons 128 and a distress button 129.

In some embodiments, the speaker 123 may transmit messages received on an operating channel. In some embodiments, the speaker 123 may always be on, such that a message that is transmitted, may be heard by the users around the speaker 123.

In some embodiments, the screen 124 may present a visual indication of various operational settings. For example, in the illustrated embodiment, the screen 124 shows the operating channel, and an indication of the volume of the speaker. In other embodiments, the screen 124 may present the weather forecast, scanning channels, the power setting, any transmitted textual messages, etc. Additionally, in some embodiments, the screen 124 may present geographic data, including coordinates of the current location, heading data, or other data associated with the watercraft.

In some embodiments, the channel operations 126 may be used to change the operating channel. In this regard, the channel may be manually changed, or a scan setting may be engaged, such that a range of channels is scanned to see if there is any activity. In the condition of activity on the channel, the VHF radio 120 may lock onto the channel such that the user may hear the activity through the speaker 123. In some embodiments, the channel buttons many include a 16/9 button which when engaged once changes the channel to 16, and when engaged twice changes the channel to 9. The 16/9 channels may be used for calling, distress, and safety, and alternate calling channels.

In some embodiments, the one or more selection buttons 128 may allow the user to toggle between the operational setting of the VHF radio 120. In some embodiments, the one or more selection buttons may include buttons to select channels or menus on the screen 124, select modes of operation, for example change to digital select calling (DCS) or other. In some embodiments, one or more joysticks may be used on the interface, while in other embodiments one or more selection arrow keys may be used to navigate the screen 124. In some embodiments, the one or more selection buttons 128 may include a squelch control, which suppresses signals below a threshold set by the user. This may eliminate static.

In some embodiments, the distress button 129 may be present on the base 121. In some embodiments, the distress button 129 may include a cover such that the cover must be lifted, or otherwise removed prior to engaging the distress button 129. In this regard, the rate of accidental distress signals may be minimized.

The VHF radio 120 may comprise a handheld portion 122 which is connected to the base 121. In some embodiments, the handheld portion 122 may include a microphone 125 such that a user may speak into the microphone 125 to transmit a message. In some embodiments, the handheld portion 122 may include a button which must be engaged to activate the microphone 125 to transmit a message. In this regard, the microphone 125 may not be constantly broadcasting, but rather only broadcast or transmit a message when necessary.

In some embodiments, the handheld portion 122 may include one or more buttons 131 to change various operational settings of the VHF radio 120. In some embodiments, the operational settings may include volume control to increase or decrease the volume either of the microphone, or the corresponding speaker 123. Other operational settings may include the operating channel, a power setting, or a distress setting.

Thus, each of the VHF radio 120 and the marine electronics device 140 are necessary for the functionality and/or safety of the watercraft 100. Notably, however, despite that the VHF radio 120 may be a key safety instrument, it is not always in use. On the other hand though, it is desirable for the VHF radio 120 to be available and be easy to use. In contrast, the amount of marine data (viewable and usable on the marine electronics device (MED) 160) that is useable and used in each and every trip is nice to have more readily available. Thus, according to various example embodiments of the present invention, by repositioning the VHF radio and integrating some of the control of the VHF radio into the MED, 140 the screens 142 may remain for presenting marine data, while still offering use of the VHF radio 120.

However, as the size of the screens 142 increase, the space for the VHF radio 120, and other communication devices decreases, and the ease of using the VHF radio 120 also decreases. As the amount of data able to be collected and presented increases, the size of the screens 142 at the helm increases, thereby decreasing the remaining amount of space at the helm 160 for other devices. Thus, integrating components of the VHF radio 120, and other communication devices, into the marine electronics device 160, may increase the ease of functionality of the VHF radio 120, while maintaining the helm space to present various marine data to the user.

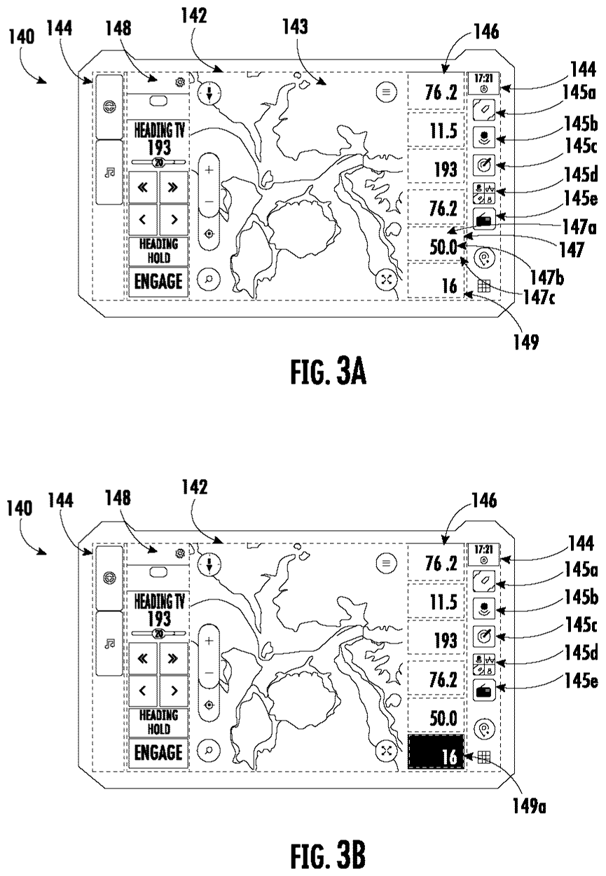

As will be discussed herein, applications and features attributed to a VHF radio may be integrated into a marine electronics device. Although discussed in relation to a VHF radio, it should be understood that applications and features of other communication devices (e.g., AIS transceivers, VDES, etc.) may be similarly integrated into the marine electronics device. FIGS. 3A-B illustrate an example display with some controls of the VHF radio integrated thereon. In some embodiments, the example marine electronics device 140 may be integrated into the helm 160 of the watercraft, while in other embodiments the marine electronics device 140 may be a handheld device. In some embodiments, the marine electronics device 140 may have one or more displays integrated into the helm of the watercraft and have one or more handheld displays for use away from the helm 160 of the watercraft. In some embodiments, the marine electronics device 140 may comprise a screen 142 to present charts and other data thereon. In some embodiments, the screen 142 may be a touch screen device, while in other embodiments the screen 142 may comprise one or more buttons, or attachments to select various items on the screen.

In some embodiments, the screen 142 may present a chart 143, for example a navigational chart as displayed in the illustrated embodiment. In addition to the chart 143, the screen 142 may present a variety of information, including menus and selectable pages.

In some embodiments, the screen 142 may present at least one side menu 144. In some embodiments, the side menu 144 may be on one or both sides of the screen 142 of the marine electronics device 140. In some embodiments, the side menu 144 may present a number of applications 145a-145e. The applications 145a-145e, when selected, may present the corresponding application on the screen 142. For example, a first application 145a may be a map application, and when selected may present the chart 143. A second application 145b may be a sonar application, and when selected may present sonar images of current or historical views of the underwater environment. In some embodiments, a radio application 145e, when selected, may present a digital view of the VHF radio, as will be discussed herein.

In some embodiments, the screen 142 may include an information column 146 which presents marine information and/or watercraft factors which may be pertinent to operation of the watercraft. For example, the information column 146 may include the current depth of the body of water, the speed over ground of the watercraft, the course over ground of the watercraft, the water temperature, the fuel remaining, radio information, and/or other factors. In some embodiments, the marine information and/or the watercraft factors included in the information column 146 may be customizable.

In some embodiments, each of the marine information or watercraft factor 147 may include a title 147a to identify the factor, an indication of the factor 147b, and a unit of the factor 147c (if necessary). In this regard, the information column 146 may provide the user with a quick overview of various factors 147 of the watercraft.

In some embodiments, the screen 142 may include an engagement menu 148. The engagement menu 148 may be brought up through one of the applications 145a-145e or may be brought up through selection of one of the marine information or watercraft factors 147. In some embodiments, the engagement menu 148 may allow the user to change the marine information, watercraft factor, or view presented on the display.

As discussed, the information column may be customizable, and may include a radio factor 149 which may be correlated and connected to the VHF radio(s) on the watercraft. In some embodiments, the radio factor 149 may identify the location of the VHF radio, and the current status of the VHF radio. For example, as illustrated in FIG. 3A the radio factor 149 indicates the VHF radio located on the Flybridge is set to channel 16. In some embodiments, the radio factor 149 may be configured to indicate the status of the radio, for example, if there are any calls or information being sent to the VHF radio. As illustrated in FIG. 3B, the radio status indication 149a is highlighted to indicate a call or other information being sent to the VHF radio. In this regard, the status indication, (e.g., change in color) may indicate to the user to go to the VHF radio and answer the call or otherwise listen to the transmission of the VHF radio, so the user may respond accordingly.

In some embodiments, the status indication of the radio indication 149 may indicate the current use of the VHF radio. For example, a first highlight may indicate the channel is free, a second highlight may indicate the channel is busy, and a third highlight may indicate a distress signal. In this regard, in addition to the VHF radio information being presented in detail on the screen 142, the user may have a quick visual indication of the status of the VHF radio.

In addition to presenting the radio factor 149 on the screen 142, in some embodiments the marine electronics device 140 may be configured to change one or more operational settings of the VHF radio at the screen 142.

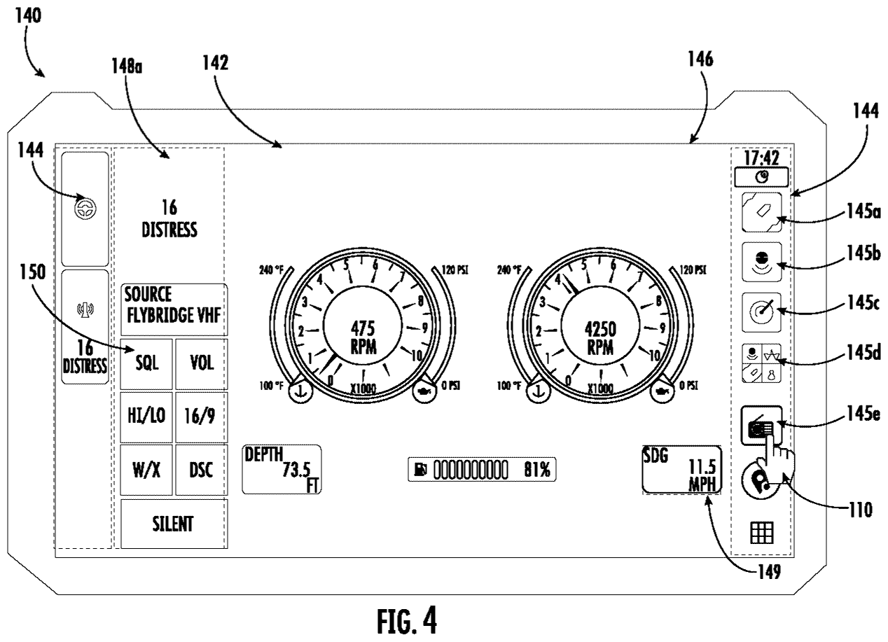

FIG. 4 illustrates the screen 142 of the marine electronics device 140 being used to engage with the VHF radio and change one or more operational settings of the VHF radio. In some embodiments, a user 110 may select the radio application 145e from the side menu 144. Upon selection, the engagement menu may change to a radio engagement menu 148a which may include a selection of various operational settings 150.

In some embodiments, the screen 142 may change from a chart 143, to a virtual VHF radio presentation, while in other embodiments only the engagement menu 148a may change. In some embodiments, the operational settings may include, an operating channel, volume, squelch, a power setting, digital standard calling, weather channel, scanning, silent, etc. In this regard, selecting any of the operational settings 150 may allow the user to change the setting from the marine electronics device 140.

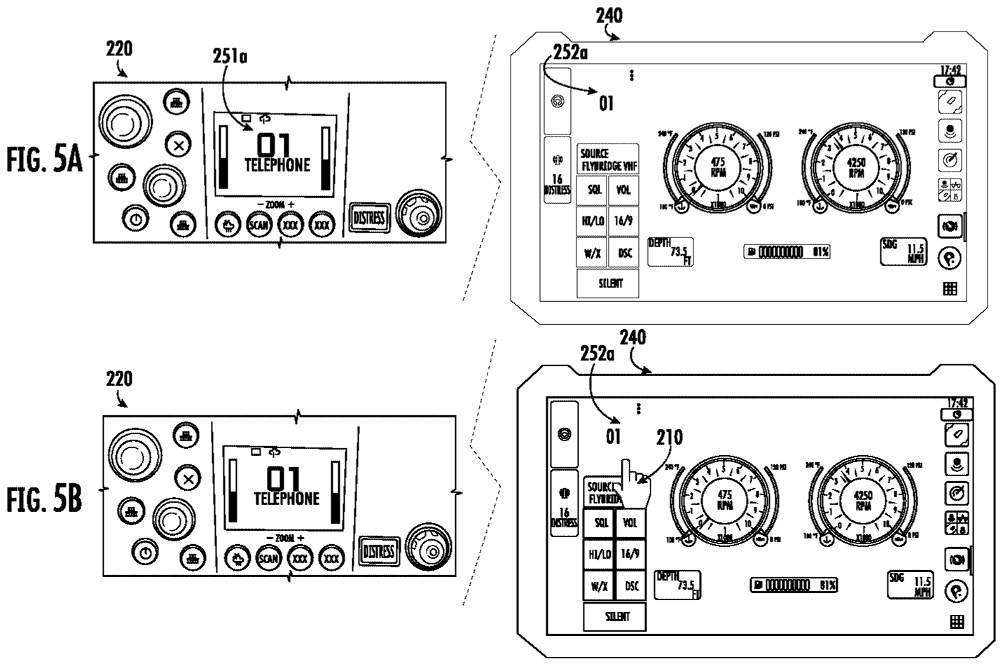

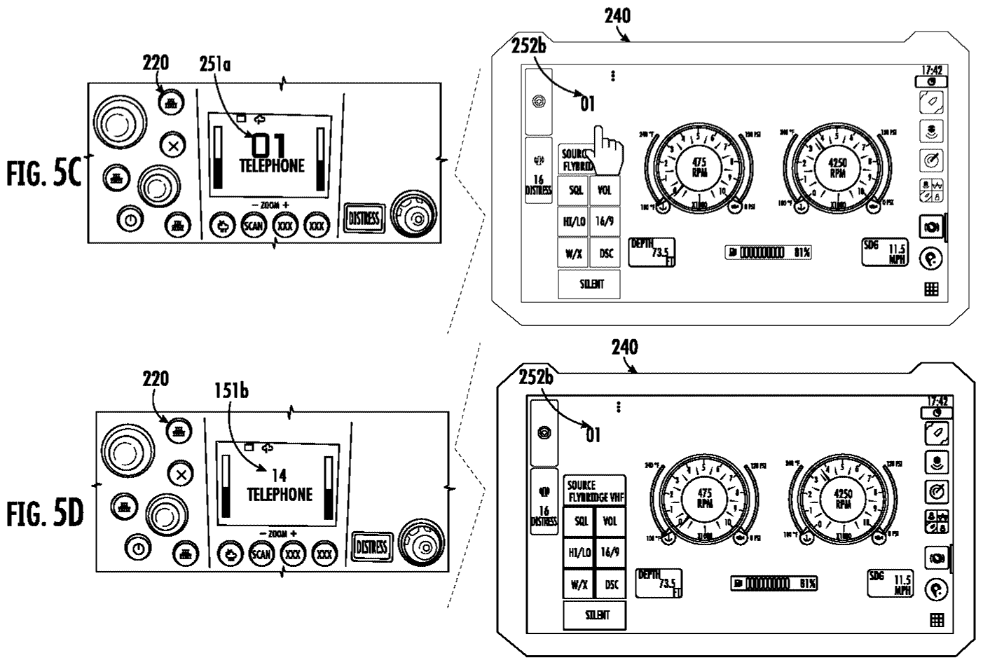

FIG. 5A through FIG. 8 illustrate example embodiments of utilizing a marine electronics device to change the operational setting and/or use various of the features of a VHF radio.

FIGS. 5A-D illustrate utilizing a marine electronics device to change the operational settings on a VHF radio. Initially, as illustrated in FIG. 5A, a marine electronics device 240 and a VHF radio 220 may present the same operational setting. In the illustrated embodiment, both the VHF radio 220 and the marine electronics device 240 show the channel being 01. In this regard, an operational setting 251a of the VHF radio 220 and an operational setting 251b of the marine electronics device 240 correspond. In order to change the operational setting of the VHF radio 220, the change may be implemented on either the VHF radio 220 or on the marine electronics device 240.

FIG. 5B illustrates a user 210 selecting the channel operational setting 252b on the marine electronics device 240 to change the operational setting. When the channel operational setting 252 is changed from channel 1 to channel 14 as illustrated in FIG. 5C, a signal may be sent to the VHF radio 220 to cause the VHF radio 220 to change the operational setting from channel 1 to channel 14. Thus, when the VHF radio 220 receives the signal to change the operational setting, the VHF radio 220 executes the change from channel 1 to channel 14 as illustrated in FIG. 5D. Although the operational setting illustrated in FIGS. 5A-5D is the channel, in other embodiments the operational setting may be the squelch level, the volume, the power output, the weather channel, etc. In this regard, data communication may be established between the VHF radio 220 and the marine electronics device 240.

Although illustrated as the user 220 changing the operational setting 252a on the marine electronics device 240 and there being a signal that is transmitted to change the operational setting 251a on the VHF radio 220, it should be understood that changing the operational setting 251a on the VHF radio 220 causes transmission of a signal to the marine electronics device 240 to change the operational setting 252a presented thereon.

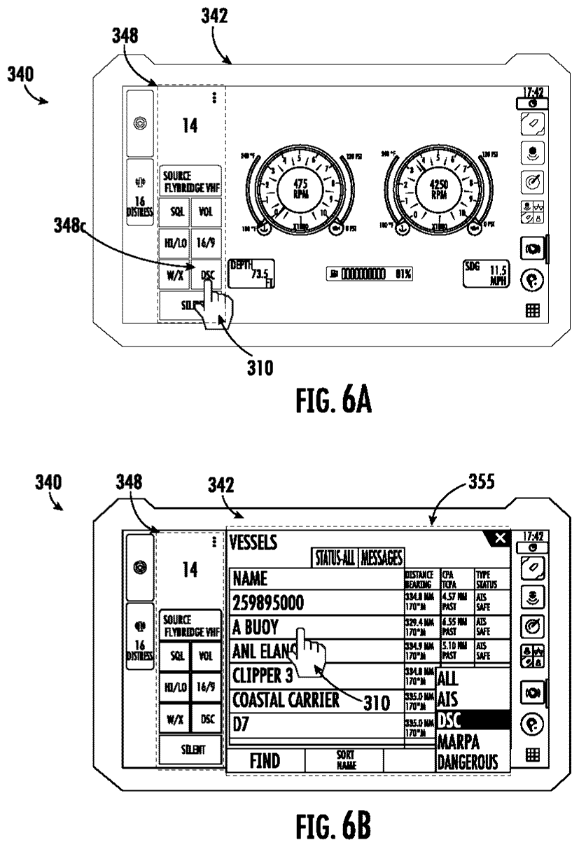

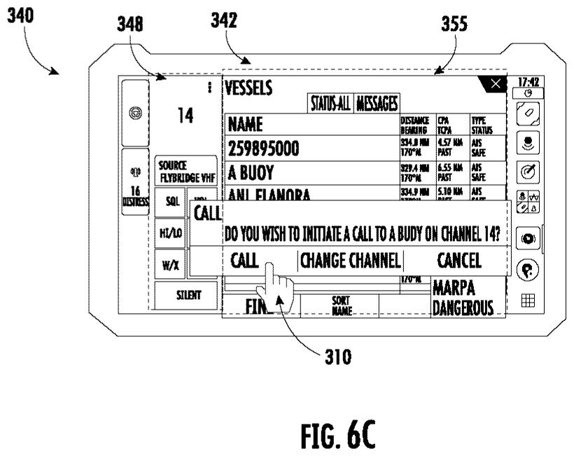

FIGS. 6A-C illustrate utilizing a marine electronics device 340 to engage a VHF radio 320 in digital selective calling (DSC). DSC allows the user to instantly send a message to nearby watercrafts, and if needed rescue authorities.

To engage in DSC, a user 310 may select a DSC option 348c from an engagement menu 348 on a display 342 of the marine electronics device 340. In some embodiments, selecting the DSC option 348c from the menu 348 may bring up a DSC menu 355. In some embodiments, the DSC menu 355 may include a list of contacts, the last known location of the contact, the status of the contact, or other information about the contacts. In addition to the list of contacts, the DSC menu 355 may include other vessels in a geographic area adjacent the watercraft. In some embodiments, selecting one or more contacts from the DSC menu 355 may allow the user to engage in DSC with the contact, on the current channel, or may prompt the user to change the channel.

Similarly, although illustrated to use DSC, the marine electronics device 340 may be used to draft and create assisted messaging to send messages between the VHF radio and other VHF radios on watercrafts in a similar vicinity. In some embodiments, the messages may be preprogramed in the marine electronics device 340 such that the user 310 may select the desired message to be sent to a secondary user. In other embodiments, the marine electronics device 340 may have a predictive text, to assist the user 310 in creating the message to be sent to other watercrafts.

In this regard, the marine electronics device 340 and the VHF radio may be in data communication such that the marine electronics device 340 may store various data from the VHF radio. For example, the VHF radio may import any contacts to the marine electronics device or may import buddy track to the marine electronics device 340.

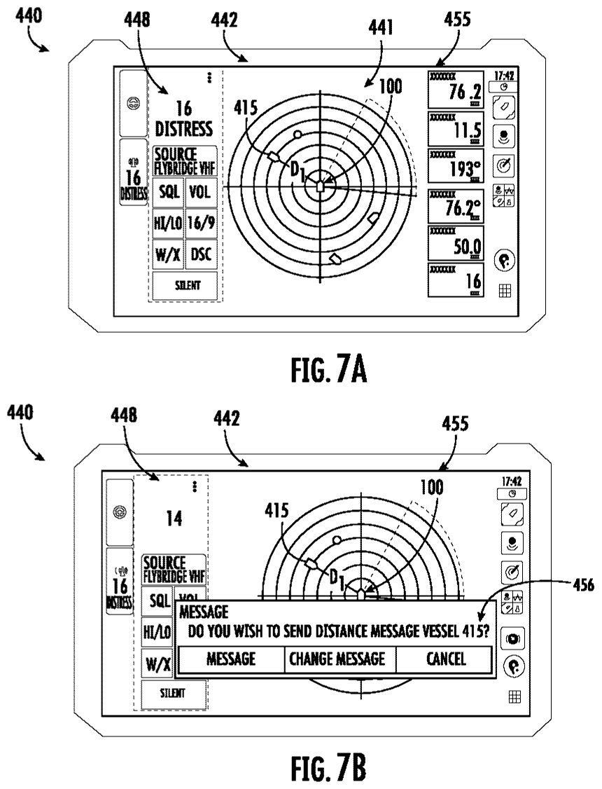

The data and electrical communication between the marine electronics device and the VHF radio may allow the system to automatically send messages. FIGS. 7A-B illustrate a marine electronics device 440 presenting a radar image 441 on a display 442. The radar image 441 depicts the watercraft 100 at the center of the image and other watercrafts about the image. In some embodiments, the system may detect an oncoming watercraft 415 which is headed in the direction of the watercraft 100. When the oncoming watercraft 415 is within a predetermined distance di of the watercraft 100, the system may automatically prompt a message to be sent to the oncoming vessel 415, as illustrated in FIG. 7B.

In some embodiments, the message may be sent automatically when the oncoming watercraft 415 reaches the predetermined distance di while in other embodiments, the system may display a message menu 456 which may prompt the user to select to send the message, change the message, or cancel the message. In some embodiments, the vessel information of the oncoming watercraft 415 may be stored in the memory of the VHF radio or the marine electronics device.

In some embodiments, the marine electronics device may interface with an AIS. The AIS transponder may continuously broadcast the watercrafts position, course, speed, and other relevant information utilizing VHF radio frequencies. In some embodiments, rather than sending a message using the VHF radio, the system may utilize the AIS to engage in collision avoidance parameters. In this regard, the AIS may interpret the radar return and determine the oncoming watercraft 415 entered into a guard zone which is within the predetermined distance di of the watercraft 100. The marine electronics device may interface with the AIS and automatically call the oncoming watercraft 415 and notify the oncoming watercraft 415 of the current location, position, heading, and/or give the oncoming watercraft guidance based off of the rules of the body of water.

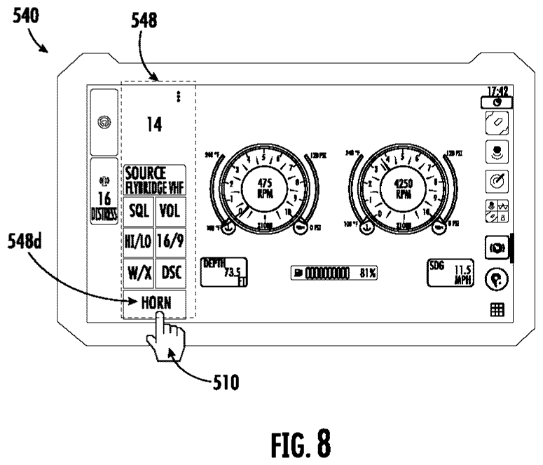

FIG. 8 illustrates utilizing a marine electronics device 540 to engage different modes on a VHF radio. In this present embodiment, a user 510 may select a horn button 548d from an engagement menu 548. In some embodiments, selecting the horn button 548d may engage a foghorn (e.g., 109 FIG. 1) on the watercraft. In some embodiments, the foghorn may typically be controlled by the VHF radio through a horn button.

In addition to a foghorn the marine electronics device 540 may be configured to cause the VHF radio to enter into other modes. For example, the marine electronics device 540 may be configured to cause the VHF radio to scan channels to determine if any channels are in use. Similarly, the marine electronics device 540 may be used to cause the VHF radio to scan weather channels. Additionally, in some embodiments, other the marine electronics device may initiate other watch modes on the VHF radio.

As discussed herein, the marine electronics device may have different levels of electronic communication, and/or data communication with the VHF radio thereby providing differing levels of engagement or interfacing. In some embodiments, the marine electronics device may have a basic control level wherein the marine electronics device may cause the VHF radio to adjust operational settings including, for example, channel control, volume control, squelch control, power level control, AIS transmission, VDES transmission and distress channels. Further, in a basic control level, the marine electronics device may provide indication of active channels. In some embodiments, the marine electronics device may have full (or more full) control of the VHF radio, such that the marine electronics device may additionally, for example, perform set up operations of the VHF radio, engage contact sync, receive and send DSC messaging, engage with a buddy track, initiate scanning and watch modes, and/or engage in autonomous or assisted messaging.

In some embodiments, engagement between the marine electronics device and the VHF radio as discussed herein may cause automatic communication with other watercrafts in the same area to, for example, prevent collisions, send out Man Overboard indications, or accomplish other functions. Further, the integration may be used to automatically call other vessels, for example vessels in the same lane or vessels in potentially dangerous zones. In some embodiments, the system may be used to send out messages to alert other vessels in the area of potentially dangerous obstacles, for example, sunken trees, other watercrafts, currents or weather.

Although discussed with reference to VHF radios, it should be understood that the marine electronics device may interface with other communication devices such as AIS transceiver, and/or VDES.

For example, the marine electronics device may interface with AIS hardware. The AIS transponder may continuously broadcast the watercrafts position, course, speed, and other relevant information utilizing VHF radio frequencies. AIS transponders may be configured to transmit and receive AIS messages and use an AIS display unit to visualize the transmitted and received AIS data. Thus, rather than use an AIS display unit, the AIS system may interface with the marine electronics device (e.g., 140) to present, receive, manipulate, and transmit AIS data at the helm, rather than from a remote location.

Similarly, the marine electronics device may interface with VDES hardware. VDES may operate using VHF radio frequencies but may provide a greater data throughput and variation on the type of information exchanged between transponders. VDES may include VDES data exchange to enable point to point communication between vessels in close proximity, or between vessels and shore-based facilities. Further, some VDES may utilize satellite communication, which provides communication over longer ranges.

In some embodiments, each of the basic control or integrations may be visually presented on the marine electronics device, as discussed with reference to FIGS. 5A-D.

Although discussed herein, as the user engaging with the marine electronics device directly, it should be understood that these actions may be taken on a remote device in data communication with the marine electronics device.

### Example System Architecture

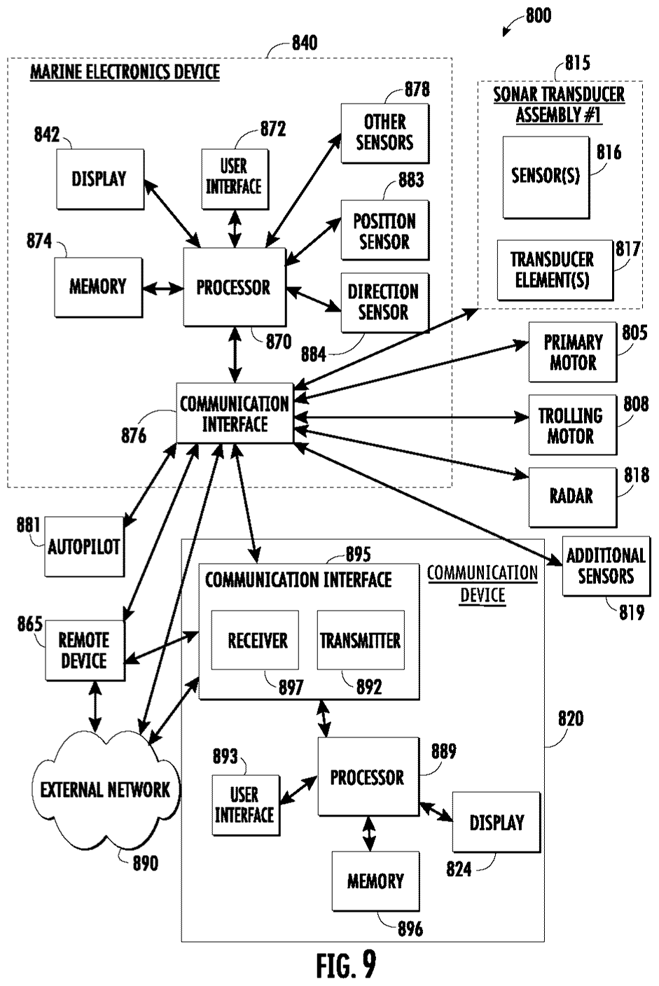

FIG. 9 illustrates a block diagram of an example system 800 according to various embodiments of the present invention described herein. The illustrated system 800 includes a marine electronics device 840 and a communication device 820. In some embodiments, the communication device 820 may be a VHF radio, and AIS system, a VDES system or similar. In some embodiments, the system 800 may comprise numerous marine devices. As shown in FIG. 9, one or more sonar transducer assemblies 815 (which may include one or more sensor(s) 816 in addition to one or more transducer element(s) 817), one or more radar 818, and an autopilot 881 may be provided. One or more marine devices may be implemented on the marine electronics device 860. For example, a position sensor 883, a direction sensor 884, and other sensors 878 may be provided within the marine electronics device 840. These marine devices may be integrated within the marine electronics device 840, mounted on or otherwise attached to the watercraft at another location and connected to the marine electronics device 840, and/or the marine devices may be implemented as a or on a remote device 865 in some embodiments. The system 800 may include any number of different systems, modules, or components; each of which may comprise any device or means embodied in either hardware, software, or a combination of hardware and software configured to perform one or more corresponding functions described herein.

The marine electronics device 840 may include at least one processor 870, a memory 874, a communication interface 876, a user interface 872, a display 842, and one or more sensors (e.g., position sensor 883, direction sensor 884, other sensors 878). One or more of the components of the marine electronics device 840 may be located within a housing or could be separated into multiple different housings (e.g., be remotely located).

The communication device 820 may include at least one processor 889, a user interface 893, a communication interface 895 (e.g., including a receiver 897 and a transmitter 892), a memory 896, and a display 824. One or more of the components of the communication device 820 may be located within a housing or could be separated into multiple different housings (e.g., be remotely located).

The processor(s) 870, 889 may be any means configured to execute various programmed operations or instructions stored in a memory device (e.g., memory 874, 896) such as a device or circuitry operating in accordance with software or otherwise embodied in hardware or a combination of hardware and software (e.g. a processor operating under software control or the processor embodied as an application specific integrated circuit (ASIC) or field programmable gate array (FPGA) specifically configured to perform the operations described herein, or a combination thereof) thereby configuring the device or circuitry to perform the corresponding functions of the at least one processor 870, 889 as described herein. For example, the at least one processor 870, 889 may be configured to receive and analyze input data to determine an operational setting and a corresponding change thereof. As another example, the processor 870, 889 may be configured to analyze incoming signals and cause an indication of the detected signals on the display 842 of the marine electronics device 840 and/or on the display 824 of the communication device 820.

In some embodiments, the at least one processor 870, 889 may be further configured to implement signal processing. In this regard, the at least one processor 870 of the marine electronics device 840 may send and receive signals, via the communication interface 876, 895, to the processor 889 of the communication device 820. For example, in some embodiment the communication device 820 may be a VHF radio, and the at least one processor 870 may receive an input through the user interface 872 of an indication to change one or more operational settings, and may send the signal, via the communication interface 876, 895 to the processor 889 of the VHF radio thereby causing the VHF radio to execute the change in the operational setting. As another example, the receiver 897 of the communication device 820 may transmit a signal to the processor 889 of the communication device 820. The processor 889 may transmit the signal, via the communication interface 895, 876 to the processor 870 of the marine electronics device 840, The processor 870 may then cause an indication of the received signal to be displayed on the display 842 of the marine electronics device 840.

In some embodiments, the at least one processor 870, 889 may be configured to perform enhancement features to improve the display characteristics of data or images, collect or process additional data, such as time, temperature, radar information, MOB indications, distress calls, GPS information, waypoint designations, current, environmental conditions (e.g., wind speed, wind direction) or others, or may filter extraneous data to better analyze the collected data.

In an example embodiment, the memory 874, 896 may include one or more non-transitory storage or memory devices such as, for example, volatile and/or non-volatile memory that may be either fixed or removable. The memory 874, 896 may be configured to store instructions, computer program code, sonar data, radar data, chart data, and additional data such as, bathymetric data, location/position data in a non-transitory computer readable medium for use, such as by the at least one processor 870, 889 for enabling the marine electronics device 840 and/or the communication device 820 to carry out various functions in accordance with example embodiments of the present invention. For example, the memory 874, 896 could be configured to buffer input data for processing by the at least one processor 870, 889. Additionally or alternatively, the memory 874, 896 could be configured to store instructions for execution by the at least one processor 870, 889. Additionally or alternatively, the memory 874, 896 could be configured to store data for extraction by the at least one processor 870, 889, for example, contact lists and/or pre drafted, or draft assisted messages.

The communication interface 876, 895 may be configured to enable communication to external systems (e.g., an external network 890, a remote device 865). In this manner, the marine electronics device 840 and/or the communication device 820 may retrieve stored data from the remote device 865 via the external network 890 in addition to or as an alternative to the onboard memory 874, 896. Additionally or alternately, the marine electronics device 840 and/or the communication device 820 may store marine data locally, for example within the memory 874, 896. Additionally or alternatively, the marine electronics device 840 and/or the communication device 820 may transmit or receive data, such as signals to change an operational setting. In some embodiments, the marine electronics device 840 and/or the communication device 820 may also be configured to communicate with other devices or systems (such as through the external network 890 or through other communication networks, such as described herein). In some embodiments, the communication interface 895 may comprise a receiver 897 and a transmitter 892. In this regard, the communication interface 895 may be configured to receive and transmit message data.

For example, the marine electronics device 840 may communicate with a propulsion system of the watercraft 100 (e.g., for autopilot control); a remote device (e.g., a user's mobile device, a handheld remote, etc.); or another system. Using the external network 890, the marine electronics device 840 may communicate with and send and receive data with external sources such as a cloud, server, etc. The marine electronics device 840 may send and receive various types of data. For example, the system may receive weather data, tidal data, alert data, current data, among others. However, this data is not required to be communicated using external network 890, and the data may instead be communicated using other approaches, such as through a physical or wireless connection via the communication interface 876. In another example the communication device 420 may communication with independent communication devices, for example radios or VHF radios, AIS, and/or VDES engaged with and/or related to other watercrafts.

The communication interface 876, 895 of the marine electronics device 840 may also include one or more communications modules configured to communicate with one another in any of a number of different manners including, for example, via a network. In this regard, the communication interface 876 may include any of a number of different communication backbones or frameworks including, for example, Ethernet, the NMEA 2000 framework, GPS, cellular, Wi-Fi, or other suitable networks. The network may also support other data sources, including GPS, autopilot, engine data, compass, radar, etc. In this regard, numerous other peripheral devices (including other marine electronics devices or sonar transducer assemblies) may be included in the system 800.

The position sensor 883 may be configured to determine the current position and/or location associated with travel of the marine electronics device 860 (and/or the watercraft 100). For example, the position sensor 883 may comprise a GPS, bottom contour, inertial navigation system, such as machined electromagnetic sensor (MEMS), a ring laser gyroscope, or other location detection system. Additionally or alternately, the position sensor 883 may be configured to determine the orientation of the watercraft 100. Alternatively or in addition to determining the location of the marine electronics device 840 or the watercraft 100, the position sensor 883 may also be configured to determine the position and/or orientation of an object outside of the watercraft 100. In some embodiments, the position sensor 883 may be configured to determine a location associated with travel of the watercraft. For example, the position sensor 883 may utilize other sensors 878 (e.g., speed sensor, and/or direction sensor 884) to determine a future position of the watercraft 100 and/or a waypoint along the route of travel.

The display 824, 842 (e.g., one or more screens) may be configured to present images and may include or otherwise be in communication with a user interface 872, 893 configured to receive input from a user. The display 824, 842 may be, for example, a conventional LCD (liquid crystal display), a touch screen display, mobile device, or any other suitable display known in the art upon which images may be displayed.

In some embodiments, the display(s) 842, 824 may present one or more sets of data (or images generated from the one or more sets of data). Such data includes chart data, radar data, sonar data, weather data, location data, position data, orientation data, environmental data, sonar data, or any other type of information relevant to the watercraft. Environmental data may be received from the external network 890, retrieved from the other sensors 878, and/or obtained from sensors positioned at other locations, such as remote from the watercraft. Additional data may be received from marine devices such as a radar, a primary motor 805 or an associated sensor, a trolling motor 808 or an associated sensor, an autopilot 881 or an associated sensor, a position sensor 883, a direction sensor 884, additional sensors 878, a remote device 865, onboard memory 874, 896 (e.g., stored chart data, historical data, stored sonar data, etc.), or other devices.

The user interface 872, 893 may include, for example, a keyboard, keypad, function keys, mouse, scrolling device, input/output ports, touch screen, or any other mechanism by which a user may interface with the system.

Although the display 842, 824 of FIG. 9 is shown as being directly connected to the at least one processor 870, 889 and within the marine electronics device 840 or the communication device 820, the display 842, 824 could alternatively be remote from the at least one processor 870, 889 the marine electronics device 840 and/or the communication device 820. Likewise, in some embodiments, the position sensor 883 and/or user interface 893, 872 could be remote from the marine electronics device 840 and/or the communication device 820

The marine electronics device 840 may include one or more other sensors/devices 878, such as configured to measure or sense various other conditions. The other sensors/devices 878 may include, for example, an air temperature sensor, a water temperature sensor, a current sensor, a light sensor, a wind sensor, a speed sensor, tide sensor, or the like.

The components presented in FIG. 9 may be rearranged to alter the connections between components. For example, in some embodiments, a marine device outside of the marine electronics device 840, such as the radar, may be directly connected to the at least one processor 870 rather than being connected to the communication interface 876. Additionally, sensors and devices implemented within the marine electronics device 840 may be directly connected to the communication interface 876 in some embodiments rather than being directly connected to the at least one processor 870.

### Example Flowchart(s) and Operations

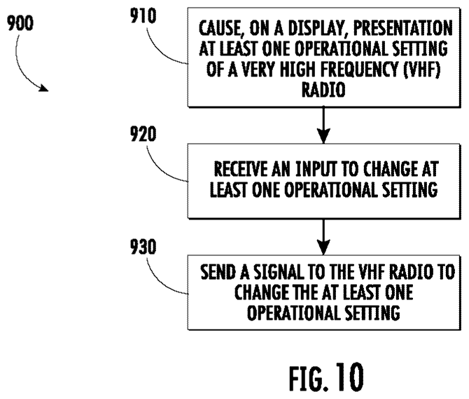

Embodiments of the present invention provide methods, apparatus and computer program products for operating according to various embodiments described herein. Various examples of the operations performed in accordance with embodiments of the present invention will not be provided with reference to FIG. 10.

FIG. 10 is a flowchart illustrating an example method 900 for changing an operational setting of a very high frequency (VHF) radio using a marine electronics device. At operation 910, presentation of at least one operational setting of the VHF radio is presented on a display. At operation 920, an input is received to change the at least one operational setting. In some embodiments, the at least one operational setting may be an operating channel, a volume, a power setting, an identifier of the VHF radio, or a location of the VHF radio. At operation 930, a signal is sent to the VHF radio to change the at least one operational setting of the VHF radio.

FIG. 10 illustrates a flowchart of a system, method, and computer program product according to example embodiments. It will be understood that each block of the flowcharts, and combinations of blocks in the flowcharts, may be implemented by various means, such as hardware and/or a computer program product comprising one or more computer-readable mediums having computer readable program instructions stored thereon. For example, one or more of the procedures described herein may be embodied by computer program instructions of a computer program product. In this regard, the computer program product(s) which embody the procedures described herein may be stored by, for example, the memory 876, 896 and executed by, for example, the processor 870, 889. As will be appreciated, any such computer program product may be loaded onto a computer or other programmable apparatus (for example, a marine electronics device 840) to produce a machine, such that the computer program product including the instructions which execute on the computer or other programmable apparatus creates means for implementing the functions specified in the flowchart block(s). Further, the computer program product may comprise one or more non-transitory computer-readable mediums on which the computer program instructions may be stored such that the one or more computer-readable memories can direct a computer or other programmable device (for example, a marine electronics device 840) to cause a series of operations to be performed on the computer or other programmable apparatus to produce a computer-implemented process such that the instructions which execute on the computer or other programmable apparatus implement the functions specified in the flowchart block(s).

### CONCLUSION

Many modifications and other embodiments of the inventions set forth herein will come to mind to one skilled in the art to which these inventions pertain having the benefit of the teachings presented in the foregoing descriptions and the associated drawings. Therefore, it is to be understood that the embodiments of the invention are not to be limited to the specific embodiments disclosed and that modifications and other embodiments are intended to be included within the scope of the invention. Moreover, although the foregoing descriptions and the associated drawings describe example embodiments in the context of certain example combinations of elements and/or functions, it should be appreciated that different combinations of elements and/or functions may be provided by alternative embodiments without departing from the scope of the invention. In this regard, for example, different combinations of elements and/or functions than those explicitly described above are also contemplated within the scope of the invention. Although specific terms are employed herein, they are used in a generic and descriptive sense only and not for purposes of limitation.

What is claimed is:

1. A system for use on a watercraft, the system comprising:
a very high frequency (VHF) radio, the very high frequency radio comprising:
an antenna;
a communication interface;
a processor; and
a memory including computer program code, the computer program code configured to, when executed cause the processor to:
receive, via the communication interface, message data; and
transmit, via the communication interface, message data; and
a marine electronics device, wherein the marine electronics device is remotely located from the VHF radio, wherein the marine electronics device is in data communication with the VHF radio, the marine electronics device comprising:
a display;
a processor; and
a memory including computer program code, the computer program code configured to, when executed, cause the processor to:
receive, through the data communication with the VHF radio, at least one operational setting of the VHF radio;
cause, on the display, presentation of the at least one operational setting;
receive an input, at the display, to change the at least one operational setting of the VHF radio; and
send a signal to the VHF radio to execute the change to the at least one operational setting of the VHF radio.

2. The system of claim 1, wherein the at least one operational setting is one of an operating channel, a volume, a power setting, an identifier of the VHF radio, a location of the VHF radio, an operation frequency, or a squelch.

3. The system of claim 1, wherein the at least one operational setting is an operating channel, and wherein the computer program code of the marine electronics device, is further configured to, when executed, cause the processor to:
receive, through the data communication with the VHF radio, a status indication of the operating channel; and
cause, on the display, presentation of the status indication of the operating channel.

4. The system of claim 1 wherein the computer program code of the VHF radio, is further configured to, when executed, cause the processor to:
receive, at the communication interface of the VHF radio, an indication of an incoming message;
transmit, via the communication interface, the incoming message to the marine electronics device; and
cause, on the display, presentation of the incoming message.

5. The system of claim 4, wherein the computer program code of the VHF radio is further configured to, when executed, cause the processor to:
receive, at the communication interface of the VHF radio, an indication of a vessel corresponding to the incoming message and corresponding contact information; and
save, in the memory, the contact information.

6. The system of claim 1, wherein the computer program code of the marine electronics device is further configured to, when executed, cause the processor to:
receive, through user input, an indication of engagement in digital selective calling (DSC);
cause, on the display, presentation of a list of contacts;
receive, at the display, an indication of a selected contact; and
send a signal to the VHF radio to engage in DSC calling with the selected contact.

7. The system of claim 1, further comprising:
at least one radar, associated with the watercraft, wherein the at least one radar is configured to emit one or more electromagnetic waves in a direction relative to the watercraft,
wherein the computer program code of the marine electronics device, is further configured to, when executed, cause the processor to:
cause the at least one radar to emit the one or more electromagnetic waves;
receive radar return data corresponding to radar returns received by the at least one radar;
generate a radar image corresponding to the radar return data;
detect one or more objects in the radar return data;
cause, on the display, presentation of the one or more detected objects within the radar image; and
cause, automatically in response to determining that a detected object from among the one or more detected objects is within a predetermined distance of the watercraft, the VHF radio to transmit a message to the detected object.

8. The system of claim 7, wherein the message is stored within the memory of the marine electronics device.

9. The system of claim 7, wherein the message is stored within the memory of the VHF radio.

10. The system of claim 1, wherein the computer program code of the marine electronics device, is further configured to, when executed, cause the processor to:
receive, at the display of the marine electronics device, an indication of engagement of a foghorn;
transmit, via the communication interface, a signal to VHF radio to engage the foghorn; and
cause the VHF radio to engage the foghorn.

11. The system of claim 1, wherein the computer program code of the marine electronics device, is further configured to, when executed, cause the processor to:
receive, an indication of a location of the VHF radio; and
cause, on the display of the marine electronics device, presentation of the indication of the location of the VHF radio.

12. The system of claim 1, wherein the computer program code of the marine electronics device, is further configured to, when executed, cause the processor to:
receive, at the display of the marine electronics device, an indication of an input, wherein the input is a VHF radio mode;
transmit, via the communication interface, a signal to the VHF radio to engage in the VHF radio mode; and
cause the VHF radio to change the VHF radio mode.

13. The system of claim 12, wherein the VHF radio mode is one of single channel, scanning, squelch, silence, weather, man overboard, and distress.

14. The system of claim 1, wherein the computer program code, is further configured to, when executed, cause the processor to:
receive, at the VHF radio, an indication of a change in at least one operational setting;
send, via the processor, instructions to the marine electronics device to cause a change in the operational setting; and
cause, on the display of the marine electronics device, presentation of the changed operational setting.

15. A marine electronics device comprising:
a display;
a processor; and
a memory including computer program code, the computer program code configured to, when executed, cause the processor to:
receive, through data communication, at least one operational setting from a very high frequency (VHF) radio, wherein the VHF radio is remote from the marine electronics device;
cause, on the display, presentation of the at least one operational setting;
receive an indication for the VHF radio to execute one or more actions corresponding to the operational setting; and
transmit instructions to the VHF radio to cause execution of the one or more actions by the VHF radio, wherein the one or more actions at least change the operational setting of the VHF radio.

16. The marine electronics device of claim 15, wherein the at least one operational setting is one of an operating channel, a volume, a power setting, an identifier of the VHF radio, a location of the VHF radio, an operation frequency or a squelch.

17. The marine electronics device of claim 15, wherein the computer program code, is further configured to, when executed, cause the processor to:
receive, at the display of the marine electronics device, an indication of an input, wherein the input is a VHF radio mode; and
transmit a signal to the VHF radio to engage in the VHF radio mode so as to cause the VHF radio to change the VHF radio mode.

18. The marine electronics device of claim 17, wherein the VHF radio mode is one of single channel, scanning, squelch, silence, weather, man overboard, and distress.

19. A method of remotely using a very high frequency (VHF) radio, the method comprising:
causing, on a display of a marine electronics device, presentation of at least one operational setting of the VHF radio, wherein the marine electronics device is connected with the VHF radio so as to provide data communication between the marine electronics device and the VHF radio;
receiving, at the display of the marine electronics device, an indication of a change in the at least one operational setting; and
sending a signal to the VHF radio to execute the change to the at least one operational setting.

20. The method of claim 19, wherein the at least one operational setting is one of an operating channel, a volume, a power setting, an identifier of the VHF radio, a location of the VHF radio, an operation frequency or a squelch.

21. A system for use on a watercraft, the system comprising:
a communication device comprising:
an antenna;
a communication interface;
a processor; and
a memory including computer program code, the computer program code configured to, when executed cause the processor to:
receive, via the communication interface, message data; and
transmit, via the communication interface, message data; and
a marine electronics device, wherein the marine electronics device is remotely located from the communication device, wherein the marine electronics device is in data communication with the communication device, the marine electronics device comprising:
a display;
a processor; and
a memory including computer program code, the computer program code configured to, when executed, cause the processor to:
receive, through the data communication with the communication device, at least one operational setting of the communication device;
cause, on the display, presentation of the at least one operational setting;
receive an input, at the display, to change the at least one operational setting of the communication device; and
send a signal to the communication device to execute the change to the at least one operational setting of the communication device.
